(19) United States
(12) Patent Application Publication
(10) Pub. No.: US 2024/0426865 A1
(43) Pub. Date: Dec. 26, 2024

(54) COLD-ATOM SENSOR WITH IMPROVED NOISE

(71) Applicant: THALES, MEUDON (FR)

(72) Inventors: Matthieu DUPONT-NIVET, PALAISEAU (FR); Benjamin WIRTSCHAFTER, PALAISEAU (FR); Soizic HELLO, Châtellerault (FR)

(21) Appl. No.: 18/662,884

(22) Filed: May 13, 2024

(30) Foreign Application Priority Data
Jun. 22, 2023 (FR) 2306475

(51) Int. Cl. G01P 15/08; G01C 19/56

(52) U.S. Cl. CPC G01P 15/08; G01C 19/56

(57) ABSTRACT

An ultracold-atom sensor includes an atom chip (ACh) comprising a first and a second waveguide (CPWX1, CPWX2) that are suitable for propagating microwave waves and DC currents, at least a first conductive wire and a second conductive wire (WId, WId1) the respective projections of which are secant at a point defining a first crossing point (C1), an atom generation device (ACG), a power supply device (PSD) comprising at least one microwave generator (GMW) and at least one DC current generator (GDC), the power supply device being configured to apply, to the first and second waveguides and to spatially separate the two traps, the microwave signals in order to initiate the spatial separation, and then the CMW electric currents instead of the microwave signals in order to maintain the spatial separation.

### CROSS-REFERENCE TO RELATED APPLICATION

This application claims priority to foreign French patent application No. FR2306475, filed on Jun. 22, 2023, the disclosure of which is incorporated by reference in its entirety.

### FIELD OF THE INVENTION

The present invention lies in the field of inertial sensors, and more specifically of cold-atom inertial sensors integrated on an atom chip. More particularly, the invention relates to on-atom-chip cold-atom sensors using microwave fields for the spatial separation of two states used when measuring inertial parameters (typically acceleration and rotational speed).

### BACKGROUND

A cold-atom interferometer interferes with two electron states, called first internal state |a> and second internal state |b> of an atom, such as rubidium 87, in a Ramsey sequence. A Ramsey interferometer sequence measures a phase p that is accumulated when implementing the sequence, from a measurement of at least one population of a chosen state |a> or |b> (preferably a measurement of both populations for greater precision). The respective populations pₐ and p_{b} of the two states |a> and |b> at the output of the interferometer are given by:

$${p}_{a} = \frac{1}{2} [ 1 - cos ( φ ) ] \qquad ( 1 )$$

$${p}_{b} = \frac{1}{2} [ 1 + cos ( φ ) ] \qquad ( 2 )$$

The phase φ is related to the energy difference between E′_{b} and E′ₐ, which are respectively equal to the energies of the states a> and |b> modified by implementing the interferometric sequence.

and

$$φ = \frac{E {′}_{b} - E {′}_{a}}{ℏ} {T}_{R} - ω {T}_{R} \qquad ( 3 )$$

where ω is the angular frequency of the local oscillator producing the two π/2 pulses at the start and at the end of the interferometric sequence, and T_{R} is the Ramsey time, that is to say the time that has elapsed between the two π/2 pulses.

Let:

$${p}_{a} = \frac{1}{2} [ 1 - cos ( \frac{E {′}_{b} - E {′}_{a}}{ℏ} {T}_{R} - ω {T}_{R} ) ] \qquad ( 4 )$$

$${p}_{b} = \frac{1}{2} [ 1 + cos ( \frac{E {′}_{b} - E {′}_{a}}{ℏ} {T}_{R} - ω {T}_{R} ) ] \qquad ( 5 )$$

It is assumed that, before the start of the Ramsey sequence, all atoms are in the state |a> and E_{b}>Eₐ where Eₐ and E_{b} are the atomic energies of the states dependent on the atom and on the transition under consideration.

To make this interferometer sensitive to accelerations and rotations, it is necessary:

In the case of accelerations, to separate the two states and then recombine them, that is to say to move them along a straight line, from their initial positions, which are identical, in two opposite directions, and then to make them travel the same path in the opposite direction until they are returned to the same position. This makes it possible to add a term related to the acceleration potential energy to the energy difference between the two states.

In the case of rotations, the two states both have to travel a closed path including a non-zero area, and to do so in opposite directions for |a> and |b>. A term dependent on the Sagnac effect, and therefore on rotational speed, is thus added to the energy difference between the two states.

To implement these trajectories, one known method is to use microwave splitters (waveguides in which microwave signals are applied). The microwave fields that are created then “dress” the states, this having the effect of creating a force that enables them to be moved. This dressing modifies the energies of the states |a> and |b>, from E′ₐ to E′ₐ and from E_{b} to E′_{b}.

The structure and the operating principle of a gyrometer sensor is described in documents U.S. Ser. No. 15/778,605, U.S. Ser. No. 17/924,340, U.S. Ser. No. 17/832,615 and U.S. Ser. No. 17/832,616 and will be recalled below. For example, document WO2017089489 describes an on-chip ultracold-atom gyroscope inertial sensor, using trapped matter waves describing closed paths including an area.

Measurements of rotation in this type of device are carried out by exploiting the Sagnac effect. The phase shift θ induced by the Sagnac effect between two matter waves counter-rotating in a reference frame rotating at an angular speed Ω, is given by:

$$θ = \frac{2 Am}{ℏ} Ω \qquad ( 6 )$$

where A is the area enclosed by the atomic paths, m is the mass of the atoms and h is the reduced Planck constant.

Ultracold atoms are defined to be atoms the temperature of which is lower than 400 nanokelvins, and preferably lower than 300 nanokelvins. The temperature of thermal ultracold atoms is, for example for rubidium atoms, between 50 and 400 nanokelvins and preferably between 100 and 300 nanokelvins.

The principle is to get a path to be traveled by two counter-propagating clouds of magnetically trapped atoms. The creation and the movement of the magnetic trap along the path are carried out by conductive wires and microwave guides, for example according to the topology illustrated in FIG. 1.

FIG. 1 schematically illustrates an ultracold-atom chip 1, ultracold atoms 12 thereof and the path 16 of two atom clouds CL1 and CL2. Part of the surface of the chip 1 forms a measurement plane 13. An axis normal to the measurement plane 13 defines the measurement axis Z, about which a measurement of rotation Ωz is performed by the gyrometer.

The chip 1 comprises means suitable for generating a first ultracold-atom trap T1 and a second ultracold-atom trap T2, a trap allowing a cloud of ultracold atoms 12 to be immobilized in an internal state different from the other trap, at a predetermined distance h from said measurement plane 13. For example, the trap T1 comprises atoms in the electron level or state |a> (cloud CL1) and the trap T2 comprises atoms in the state |b> (cloud CL2). The levels |a> and |b> are separated by a frequency ω₀/2π. For example, in the case of rubidium 87 it is a question of the two hyperfine levels |F=1,m−_{F}=−1> and |F=2,m−_{F}=1>, which are separated by about 6.8 GHz.

These means also allow the clouds to be moved along the path 16, which is located in a plane parallel to the measurement plane 13, at a height h from this plane, such as illustrated in FIG. 1. These means consist of waveguides and conductive wires such as described below.

The means comprise a first waveguide CPW1 and a second waveguide CPW2 that are suitable for propagating microwaves at angular frequencies ω_{b} and ωₐ. The waveguides are arranged symmetrically, preferably parallel, with respect to a Y-axis of the measurement plane. The two waveguides CPW1 and CPW2 are connected to at least one generator for generating voltage or current at microwave frequencies. For example, each of the waveguides is produced by depositing three conductive wires parallel so as to form a coplanar waveguide. In other embodiments, other types of waveguides may be used, in particular waveguides production of which is compatible with microfabrication techniques employing deposition or etching. It is possible, for example, to produce a microstrip line.

The means also comprise conductive wires that are integrated into the chip 1 and able to be passed through by DC currents. The conductive wires are assorted into a conductive wire WIz along an axis of symmetry Y perpendicular to X and contained in the measurement plane 13, and into a plurality of n conductive wires WIdi, the index i varying from 1 to n, that are mutually parallel and parallel to the X-axis, n being at least equal to 2. In the example of FIG. 1, n=3, i.e. there are three conductive wires WId1, WId2 and WId3. The wires are arranged so as to define n crossing points Ci (crossing between WIz and WIdi) located on the Y-axis, and here 3 crossing points C1, C2, C3.

Each conductive wire is connected to one or more current and/or voltage generators, themselves connected to a processing unit comprising at least one microprocessor. The voltage and/or current generators allow both DC currents and AC currents to be driven through the wires. In particular, DC currents are driven through the conductive wires.

In the sensor, the atom chip 1 is placed in a vacuum chamber the vacuum of which is for example maintained using an ion pump and that preferably comprises magnetic shielding. The sensor comprises an ultracold-atom generation device that comprises:
an atom dispenser, for example one achieved by a heated filament that generates a rubidium vapor;
a primary (optical and/or magnetic) atom trap, allowing a cloud of ultracold atoms to be pre-cooled and placed in the vicinity of the chip, with a view to loading the magnetic traps T1 and T2 described below with atoms.

The sensor also comprises a magnetic-field source, external to the chip 1. It allows a uniform and static magnetic field Bc to be generated over a thickness at least of the order of a height h above the measurement plane 13. Advantageously, the direction of the uniform magnetic field is parallel to the measurement plane.

In FIG. 1, the path 16 in dotted lines illustrates the path of the clouds of ultracold atoms 12. This closed path defines an area denoted A. A distance h separates the plane of the path 16 and the measurement plane 13 of the chip. Preferably, h is between 500 nm and 1 mm, and preferably between 5 μm and 500 μm.

FIG. 2 illustrates the geometry of the guides and wires of the atom chip as well as the traps T1 and T2.

The specific arrangement of the conductive wires and of the waveguides, in association with the source of the uniform magnetic field, makes it possible to easily obtain two traps T1 and T2 as illustrated in part a) of FIG. 2. Each trap T1 and T2 has the same non-zero minimum value V0, and an identical curvature, a necessary condition for the sensor to operate. Specifically, as explained below, when a DC current is applied to at least two conductive wires of a crossing point, the minimum of the potential is located plumb with this crossing point. When microwave power is then sent through the waveguides, the central minimum is converted into two minima that are located on either side of the initial minimum in the direction of the waveguides. If the initial minimum is not located strictly at equal distance from the two waveguides, the two potential minima created will not have strictly the same minimum value V0 and the same curvature.

Part c) of FIG. 2 illustrates the layout of the conductive wires defining the initial crossing point C1 and of the waveguides (seen from above). Part b) of FIG. 2 describes the corresponding layout of the conductive wires and of the waveguides printed on a chip seen in cross-sectional profile, the cross section being through the conductive wire WId1, which intersects the conductive wire WIz along the axis of symmetry Y. The waveguides CPW1 and CPW2 are coplanar waveguides located on a first level N1. The isolating layer 18 advantageously allows the measurement plane to be flattened. The material of the electrically isolating layer may for example be silicon dioxide, silicon nitride or benzocyclobutene. A conductive material, gold for example, is used to manufacture the conductive wires, and is deposited on a substrate 15, forming a second level N2. The substrate may for example be made of silicon, of aluminum nitride or of silicon carbide.

Part a) shows the symmetrical separation of ultracold atoms, which is specific to the internal state of said ultracold atoms, and more precisely to variations in potential as a function of position on the X-axis of the chip 1.

Curve “a” shows a potential well corresponding to the association of the uniform magnetic field and of the field created by two secant conductive wires—the wire WIz passed through by the current I_{z} and the wire WId1 passed through by the current Id1. A local potential well forming a three-dimensional atom trap T is generated. A cloud of ultracold atoms may be trapped therein and cooled.

Curve “b” schematically shows the potential created by the transmission of microwaves at the frequency ω_{b} through the waveguide CPW1. The field emitted by the passage of microwaves at the frequency Ω_{b} allows the energy of the ultracold atoms to be modified and the atoms of internal states |b> to be moved. Curve “e” illustrates the potential seen by the internal states |b> as a result of the contributions of the potentials illustrated by curve “a” and by curve “b”. Curve “e” has a local potential minimum allowing a cloud of ultracold atoms of internal states |b> to be trapped locally.

Similarly, curve “d” schematically shows the potential created by the transmission of microwaves at the frequency ωₐ through the waveguide CPW2. The field emitted by the passage of microwaves at the frequency ωₐ allows the energy of the ultracold atoms to be modified and the atoms of internal states |a> to be moved. Curve “c” illustrates the potential seen by the atoms of internal states |a> as a result of the contributions of the potentials illustrated by curve “a” and by curve “d”. Curve “c” has a local energy minimum allowing a cloud of ultracold atoms of internal states |a> to be trapped locally.

The association of a DC magnetic trap (created by the DC currents in the wires and the uniform field Bc) and of a microwave field creates what is called a “dressed” trap. The term “dressed” is understood to mean a trap created at least in part by a microwave, radiofrequency or optical oscillating field. The changes in microwave fields (power, frequency and guide in which they propagate) make it possible to move this dressed trap, and therefore to move the atoms. The DC magnetic trap is represented in FIG. 2 by curve a. The microwave field at ωₐ is represented in FIG. 2 by curve d and the microwave field at ω_{b} is represented in FIG. 2 by curve b. The dressed trap T1 (association of curves a and d) for the state |a> is represented by curve c and the dressed trap T2 (association of curves a and b) for the state |b> is represented by curve e.

Clouds of ultracold atoms of internal states |a> and |b> may be separated and trapped symmetrically with respect to the axis of symmetry Y by simultaneously making waves of frequency ωₐ propagate through CPW2 and waves of frequency ω_{b} propagate through CPW1. To obtain two traps the minima of which are of the same value V0 and the curvatures of which are of the same value, it is important for the crossing point C1 to be placed at an equal distance from CPW1 and CPW2, on the axis of symmetry Y.

FIG. 3 illustrates the principle of generation of the path 16. Part a) of FIG. 3 schematically shows a sequence of the movement of each of the clouds of ultracold atoms at characteristic times t₁ to t₉. Part b) illustrates, in a complementary manner, a sequence of the various currents applied to the conductive wires, of the powers applied to the waveguides and of the frequencies applied to the waveguides, at the times corresponding to the times of part a).

In the sequence presented in FIG. 3, the current I_{z} (not shown) flowing through WIz is static and at a constant value. In part b), the values of the currents, of the powers and of the frequencies are arbitrary values. The y-axis labelled 6 frequency corresponds to a frequency variation expressed in arbitrary units about an average frequency value. The currents passing through the conductive wires may be between 100 μA and 10 A, and the angular frequencies injected into the waveguides may be between 6.6 GHz and 7 GHz in the case of use of rubidium atoms.

In a step A0, there is a phase of preparing the atoms. A cloud of ultracold atoms 12 is generated, this including phases of dispensing said atoms, of cooling said atoms, of initializing said atoms to at least one internal state |a> and of trapping a cloud of said ultracold atoms in a local potential minimum, at a distance h from the measurement plane (trap T, curve “a” of FIG. 2 part a)). The height h is different from 0 because the uniform magnetic field Bc is non-zero. Trapping is achieved by passing DC currents through the wire WIz and through one of the wires WIdi, the crossing point of these two wires defining the start point (here C1 with WId1). At the same time, a bias magnetic field Bc is applied parallel to the plane of the atom chip, which field superposes on the magnetic field created by the preceding two wires. The cloud of atoms is then trapped plumb with C1, the intersection of the wires WIz and WId1.

In a step B0, the internal states are initialized by coherently superposing said ultracold atoms between said states |a> and |b> via a first π/2 pulse. This pulse may be produced by a laser, a microwave emitter, or more generally using a method whereby waves are emitted at a suitable transition frequency. Currents I_{z} and I_{d1} are applied to the conductive wires WIz and WId1, respectively. The two internal states |a> and |b> are superposed coherently and spatially plumb with the crossing point C1.

The wave function is then:

$$\frac{\vert a > + \vert b >}{\sqrt{2}}$$

In a step C0, a cloud of atoms of internal state |a> in one trap T1 is spatially separated from a cloud of atoms of internal state |b> in another trap T2, and the traps are moved in opposite directions along a closed path 16 contained in a plane perpendicular to the measurement axis Z. The cloud of atoms of internal states |a> has been symbolized by a disk of light texture, and the cloud of atoms of internal states |b> has been symbolized by a disk of darker texture. This step runs from t1 to t9.

Between t₁ and t₂, the microwave power injected into the waveguides CPW1 and CPW2 gradually changes from 0 to its maximum value. An angular frequency ω_{b} is sent to the waveguide CPW1 and an angular frequency ωₐ is sent to the waveguide CPW2, this allowing the two clouds of different internal states to be separated on either side of the axis of symmetry Y, by a distance d, to the positions schematically shown for t₂. The ultracold-atom trap T described above at the time t₁ is thus converted into two ultracold-atom traps T1 and T2, each trap allowing a cloud of ultracold atoms of internal states different from the other trap to be immobilized (in the present case, internal states |a> in one of the traps, for example T1, and internal states |b> in the other trap T2, as described in part a) of FIG. 2).

A crossing point Ci corresponds to the crossing of the wire WIz with the wire WIdi.

Between t₂ and t₃, the current I_{d1} is gradually cut and I_{d2} is gradually brought to its maximum value (the time interval separating t₂ and t₃ is typically of the order of 10 ms and may be between 0.1 ms and 100 ms): the two traps T1 and T2 are moved to the right to the positions schematically shown for t₃.

Between t₃ and t₄, the current I_{d2} is gradually cut and I_{d3} is gradually brought to its maximum value: the two traps are moved to the right to the positions schematically shown for t₄.

Between t₄ and t₅, the microwave power is gradually cut: the two traps are brought back to the same place on the chip, as schematically shown for t₅.

At t₅, the angular frequencies of the two microwave guides are modified: the angular frequency ωₐ is applied to CPW1 and the angular frequency ω_{b} is applied to CPW2.

Between t₅ and t₆, the power in the two waveguides gradually changes from 0 to its maximum value: the traps are separated in the vertical direction as schematically shown in the figure for t₆.

Between t₆ and t₇, the current I_{d3} is gradually cut and I_{d2} is gradually brought to its maximum value: the two traps T1 and T2 are moved to the left to the positions schematically shown for t₇.

Between t₇ and t₈, the current I_{d2} is gradually cut and I_{d1} is gradually brought to its maximum value: the two traps are moved to the left to the positions schematically shown for t₈. This operation may be repeated a number of times with other first conductive wires to increase the area enclosed by the path 16.

Between t₈ and t₉, the microwave power in the waveguides is gradually cut. The two traps T1 and T2 move until they merge into a single trap located at the start point schematically shown for t₁.

DC currents are thus applied to the two wires corresponding to the initial crossing point C1, and over time these currents are successively applied to the various crossing points Ci located on the axis of symmetry, while simultaneously applying microwave power to the waveguides.

During step C0, the DC currents applied to the various wires WIdi vary continuously (increase and decrease) between 0 and a maximum value Idimax (normalized to 1 in FIG. 3), whereas the magnetic field Bc and the current I_{z} remain constant during the sequence. Throughout the sequence A0, B0 and C0, the two traps T1 and T2 remain at the height h.

The two traps T1 and T2 move in the direction of “turn-on” of the crossing points: from the crossing point C1 to the crossing point Cn. The return trip is made by inverting the microwave frequencies and turning on the DC currents successively in the wires corresponding to the various crossing points, passing through them from Cn to C1.

The traps are thus made to travel the closed path 16.

The closed path 16 of the atoms then contains an area A, and the atom wave function is therefore:

$$\frac{\vert a > + exp ( i φ ) \vert b >}{\sqrt{2}}$$

$$with :$$

$$φ = {ω}_{0} t + \frac{m}{ℏ} {Ω}_{z} A$$

In a step D0, the internal states |a> and |b> are recombined by applying a second π/2 pulse to the ultracold atoms, this transferring the phase difference to the populations of the two atomic levels:

$${p}_{a} = \frac{1}{2} [ 1 - cos ( φ - ω t ) ]$$

$${p}_{b} = \frac{1}{2} [ 1 + cos ( φ - ω t ) ]$$

where ω is the angular frequency of the π/2 pulse.

The π/2 pulses may be sent to the atoms via the microwave guides or via a separate microwave emitter.

The sequence from the first i/2 pulse to the second i/2 pulse inclusive is the Ramsey sequence (see above).

Next, in a step E0, the density of atoms in at least one internal state chosen from at least |a> and |b> is measured. This measurement may be for example carried out by using laser absorption to probe the resonance between the angular frequency specific to an internal state and the angular frequency of the laser. The Sagnac phase shift of the ultracold atoms is then determined and the rotational speed of the sensor about the Z-axis is computed.

Measurement of at least one population of atoms in one of the states |a> or |b> allows the Sagnac phase shift to be determined, for example for the internal state |a>, using equation (1), then the rotational speed Ω_{z} to be determined using equation (6).

The traps may be made to travel this path N times before the Sagnac phase shift is measured, and thus a phase shift that will potentially be N times higher may be measured.

In order to implement the method described above, the ultracold-atom sensor allowing a measurement of rotational speed Ω_{z} comprises:
an atom chip 1 as described above, with the waveguides and conductive wires,
an atom generation device for generating the cloud of ultracold atoms near the measurement plane 13 of the atom chip,
a generator for generating the uniform magnetic field Bc,
at least one DC current or voltage generator suitable for controlling electric currents in the conductive wires and at least one microwave current or voltage generator connected to the waveguides,
a detection system, typically for detecting an optical intensity, that is suitable for measuring at least one population of ultracold atoms in an internal state, this measurement allowing Sagnac phase shift and rotational speed Ω_{z} to be determined.

The gyroscope sensor also comprises at least one processor that controls the operation and the implementation of the sensor, such as the driving of the signals applied to the wires and to the microwave guides in a predetermined sequence (for example the sequence of FIG. 3b).

An accelerometer sensor exhibits “simplified” operation compared to the gyroscope, since the two clouds follow a straight outward and return path, as illustrated in FIG. 4, which uses the same logic and the same formalism as FIG. 3. A single wire WId is needed here, defining the crossing point C.

Part a) of FIG. 4 schematically shows a sequence of the movement of each of the clouds of ultracold atoms at characteristic times t₁ to t₃. Part b) illustrates the sequence of the various currents applied to the conductive wires, of the powers applied to the waveguides and of the frequencies applied to the waveguides, at the times corresponding to the times of part a). In the sequence presented in FIG. 4, the current I_{z} (not shown) flowing through WIz is static and at a constant value. The current applied to WId is also constant throughout the sequence.

Initially at t₁, no power is applied to the waveguides and the cloud is trapped above the point C.

Between t₁ and t′1, the microwave power injected into the waveguides CPW1 and CPW2 gradually increases from 0 to its maximum value, and then the value remains at a maximum and constant between t′1 and t′2 passing through T2. An angular frequency ωₐ is sent to the waveguide CPW2 and an angular frequency ω_{b} is sent to the waveguide CPW1, this allowing the two clouds of different internal states to be separated on either side of the axis of symmetry Y to the positions schematically shown for t₂, these positions being maintained throughout the duration t′2−t′1, which may be small.

Between t′₂ and t₃, the microwave power in the waveguides is gradually cut. The two traps T1 and T2 move until they merge into a single trap located at the start point schematically shown for t₁.

For the two types of sensor, and generally for any inertial sensor, considering formulas 3, 4 and 5, it is seen that the phase is sensitive to the energy difference between the two “dressed” levels E′_{b}−E′ₐ, which is expressed as a function of the energy difference between the two atomic levels Eₐ−E_{b}:

For the state |a>, the energy is modified from Eₐ to E′ₐ, with:

$${E}_{a}^{′} = {E}_{a} + ℏ \frac{{Ω}_{a}^{2}}{4 {Δ}_{a}} \qquad ( 7 )$$

For the state |b>, the energy is modified from E_{b} to E′_{b}, with:

$${E}_{b}^{′} = {E}_{b} - ℏ \frac{{Ω}_{b}^{2}}{4 {Δ}_{b}} \qquad ( 8 )$$

Where Ωₐ (respectively Ω_{b}) is the Rabi frequency associated with the dressing of the state |a> (respectively |b>). To lighten the notations, all coupling factors are classified in the Rabi frequency, a function of the square root of the microwave power applied to the waveguides (amplitude of the microwave field).

Δₐ (respectively Δ_{b}) is the mismatch between the frequency ωₐ (respectively ω_{b}) of the microwave field dressing the state |a> (respectively the state |b>) and the frequency of the transition ω₀ₐ (respectively ω_{b0}) under consideration for dressing the state |a> (respectively |b>). The frequencies ω₀ₐ and w_{0b} are the frequencies of the atomic transitions used to implement the interferometer.

The following is obtained:

$${Δ}_{a} = {ω}_{a} - {ω}_{0 a} \qquad ( 9 )$$

$${Δ}_{b} = {ω}_{b} - {ω}_{0 b} \qquad ( 10 )$$

ω_{hfs} denotes the hyperfine frequency of the transition that is used.

One example of a transition that is used is the σ transition of rubidium 87 between two hyperfine levels F=1 and F=2, as illustrated in FIG. 5, each level having Zeeman sublevels separated by the same magnitude αB, with α=700 kHz/G for rubidium 87, B being the DC magnetic field to which atoms are subjected.

The following is obtained:

$${ω}_{0 a} = {ω}_{hfs} - α B \qquad ( 11 )$$

$${ω}_{0 b} = {ω}_{hfs} + α B \qquad ( 12 )$$

The energy difference between |a> and |b> to which the Ramsey interferometer is sensitive is then expressed as:

$${E}_{b}^{′} - {E}_{a}^{′} = {E}_{b} - {E}_{a} + ℏ \frac{{Ω}_{a}^{2}}{4 {Δ}_{a}} + ℏ \frac{{Ω}_{b}^{2}}{4 {Δ}_{b}} = {E}_{b} - {E}_{a} - Δ E \qquad ( 13 )$$

$$with$$

$$Δ E = ℏ \frac{{Ω}_{a}^{2}}{4 {Δ}_{a}} + ℏ \frac{{Ω}_{b}^{2}}{4 {Δ}_{b}} \qquad ( 14 )$$

The term ΔE is involved in the population oscillations given above (formulas 5 and 6), therefore on the phase, and is at the origin of the interferometer noise.

In practice, to ensure the operation of the interferometer (to guarantee symmetry), it is necessary to choose Ωₐ²=ω_{b}² and Δₐ=−Δ_{b} (see for example the publication “Symmetric microwave potentials for interferometry with thermal atoms on a chip” Ammar et al., Phys. Rev. A 91, 053623; 2015). This choice has the advantage of canceling out the previous term and therefore removing its effect. However, in practice, the cancelation of this term ΔE is not perfect, and therein lies the difficulty. This is all the more problematic insofar as, experimentally:
the powers of the two microwave fields, which are proportional to, ωₐ² and ω_{b}², exhibit noise, and the equalization of the two Rabi frequencies is never perfect;
the two mismatch terms Δₐ and Δ_{b} involve the value of the DC magnetic field trapping the atoms, which also contains noise (see formulas 9 to 12):

$${Δ}_{a} = {ω}_{a} - {ω}_{hfs} - α B \qquad ( 15 )$$

$${Δ}_{b} = {ω}_{b} - {ω}_{hfs} + α B \qquad ( 16 )$$

It may be seen in the above formulas that the interferometer noise originates from the DC magnetic field B, comprising the uniform magnetic field Bc applied to the atoms and the DC magnetic field coming from the conductive wires (term Δ), on the one hand, and from the microwave field (term Q), on the other hand.

Current solutions for reducing noise on the DC magnetic field consist in using the most stable current sources possible. Current solutions for reducing noise on the microwave field amplitude consist in creating feedback loops on the amplitude of the microwave field in order to stabilize it as best possible.

These two solutions are not satisfactory because, although they make it possible to reduce the noise level, these noises are still present in the error budget of the sensor.

### SUMMARY OF THE INVENTION

One aim of the present invention is to rectify the abovementioned drawbacks by proposing an ultracold-atom inertial sensor having an attenuated noise level.

One subject of the present invention is an ultracold-atom sensor comprising:
an atom chip placed in a vacuum chamber, comprising an XY-plane, referred to as a measurement plane, normal to a Z-axis, and comprising:
   a first and a second waveguide that are suitable for propagating microwave waves and DC currents,
   at least a first conductive wire and a second conductive wire the respective projections of which are secant at a point defining a first crossing point,
an atom generation device configured to generate a cloud of ultracold atoms near said XY-plane of said atom chip,
a generator for generating a uniform magnetic field,
a power supply device comprising at least one microwave generator and at least one DC current generator, the power supply device being configured to:
   apply microwave signals and DC electric currents, referred to as CMW
   currents, to said first and second waveguides,
   apply DC currents, referred to as CWI currents, to said conductive wires,
      said waveguides, said conductive wires and said power supply device being configured, when the sensor is implemented, to spatially separate a first cloud of ultracold atoms in a first internal state from a second cloud of ultracold atoms in a second internal state, forming first and second ultracold-atom traps, respectively, by modifying an energy of said ultracold atoms, and to move said traps along a linear or closed path contained in a plane perpendicular to Z,
      said power supply device being configured to apply, to said first and second waveguides and to spatially separate the two traps, said microwave signals in order to initiate said spatial separation, and then said CMW electric currents instead of said microwave signals in order to maintain said spatial separation,
      the sensor furthermore comprising a detection system suitable for measuring at least one population of said ultracold atoms in a said internal state.

According to one embodiment, the sensor is an accelerometer, the path followed by the two traps being linear.

According to another embodiment, the sensor is a gyroscope comprising a plurality of second conductive wires defining a plurality of crossing points, said path followed by the two traps being closed and traveled in the opposite direction by the first and the second trap.

According to one embodiment, each waveguide comprises three wires, two external ground wires and an internal signal wire, the CMW current being injected into the signal wire.

According to one embodiment, the power supply device furthermore comprises at least one bias tee connected to said at least one microwave generator and to said at least one DC current generator, and configured to apply said microwave signals and said CMW currents to said waveguides.

According to another aspect, the invention relates to a method for measuring an inertial parameter using an ultracold-atom sensor comprising an atom chip placed in a vacuum chamber, comprising an XY-plane normal to a Z-axis referred to as a measurement plane, said atom chip comprising:
a first and a second waveguide that are suitable for propagating microwave waves and DC currents,
at least a first conductive wire (W1) and a second conductive wire the respective projections of which are secant at a point defining a first crossing point,
   the method comprising the following steps:
   A Generating a cloud of ultracold atoms near said XY-plane of said atom chip, including phases of dispensing said atoms, of cooling said atoms, of initializing said atoms to at least a first internal state, and of trapping a cloud of said ultracold atoms in a local potential minimum, at a controlled height from said XY-plane, said trapping being carried out by passing DC currents through the first and second conductive wires,
   B Initializing the first internal state and a second internal state of said ultracold atoms by coherently superposing said ultracold atoms between said first and second internal states by way of a π/2 pulse,
   C Spatially separating a first cloud of ultracold atoms in the first internal state from a second cloud of ultracold atoms in the second internal state by forming a first and second ultracold-atom trap, respectively, by modifying energies of said ultracold atoms, and moving said traps along a linear or closed path contained in a plane perpendicular to Z and initialized at the first crossing point, said step of separating and moving the ultracold atoms being carried out by applying, in a predetermined sequence, a uniform magnetic field to said ultracold atoms, DC currents, referred to as CWI currents, to said conductive wires, and microwave signals (I_{MW}) and DC electric currents, referred to as CMW currents, to said waveguides, the separation step comprising an initialization sub-step comprising applying said microwave signals to said waveguides, and a maintenance sub-step comprising applying said CMW currents instead of said microwave signals,
   D Recombining said first and second internal states by applying a second π/2 pulse to said ultracold atoms,
   E Measuring at least one population of said ultracold atoms in at least one said internal state.

According to one embodiment, the separation step comprises a transient sub-step between the initialization sub-step and the maintenance sub-step, comprising turning off the microwave signals and turning on the CMW currents.

According to a first embodiment, during the transient step, the turning off of the microwave signals and the turning on of the CMW currents take place at the same time. According to one embodiment, the transient step has a duration of less than 100 μs.

According to a second embodiment, during the transient step, said turning off of the microwave signals takes place before or after said turning on of the CMW currents.

According to one embodiment, during the movement step, the two clouds are spatially recombined by gradually turning off the CMW currents.

According to one embodiment, during the movement step, the two clouds are spatially recombined by turning off the CMW currents and by simultaneously turning the microwave signals back on, and then by gradually turning off the microwave signals.

The following description presents a number of exemplary embodiments of the device of the invention: these examples do not limit the scope of the invention. These exemplary embodiments contain not just features that are essential to the invention but also additional features associated with the embodiments in question.

### BRIEF DESCRIPTION OF THE DRAWINGS

The invention will be better understood and other features, aims and advantages thereof will become apparent from the following detailed description, which is given with reference to the appended drawings, which are given by way of non-limiting example and in which:

FIG. 1, already cited, illustrates one example of the topology of an atom chip comprising conductive wires and microwave guides for moving magnetic traps along a closed path.

FIG. 2, already cited, illustrates the geometry of the guides and wires of the atom chip along with the traps T1 and T2.

FIG. 3, already cited, illustrates, in the lower part thereof, one example of applying the various signals to the wires and guides according to the prior art, in the case of a gyroscope sensor, to cause the two traps T1 and T2 (and therefore the two clouds of trapped atoms) to travel the closed path, and, in the upper part thereof, the position of the two clouds corresponding to chosen times.

FIG. 4, already cited, illustrates, in the lower part thereof, one example of applying the various signals to the wires and guides according to the prior art, in the case of an accelerometer sensor, to cause the two traps T1 and T2 (and therefore the two clouds of trapped atoms) to travel the linear path, and, in the upper part thereof, the position of the two clouds corresponding to chosen times.

FIG. 5, already cited, illustrates the a transition of rubidium 87 between two hyperfine levels F=1 and F=2 used for a cold-atom inertial sensor, along with the various frequencies of interest.

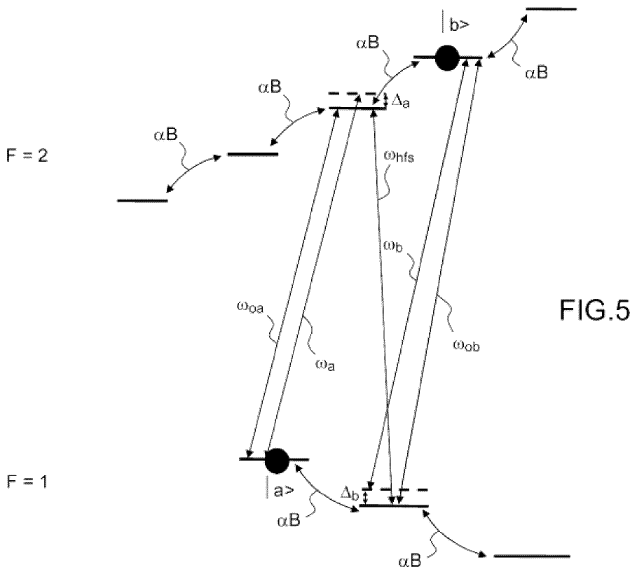

FIG. 6 illustrates the DC magnetic potential V_{DC-MW} created by applying DC currents to the waveguides.

FIG. 7 illustrates an ultracold-atom sensor 10 according to the invention.

FIG. 8 illustrates the block diagram of one embodiment of the sensor according to the invention in which the superposition of a microwave current and a DC current in the signal wire of the waveguide is carried out with a bias tee.

FIG. 9 illustrates one embodiment in which an additional bias tee TPol_{add} has been integrated at the output of the waveguide and before the termination TMW.

FIG. 10 illustrates, in the left-hand part thereof, the timing diagrams for the application of the various signals when implementing an accelerometer sensor according to the first spatial recombination variant, and, in the right-hand part thereof, the movement of the two clouds at chosen times.

FIG. 11 illustrates, in the left-hand part thereof, the timing diagrams for the application of the various signals when implementing an accelerometer sensor according to the second spatial recombination variant, and, in the right-hand part thereof, the movement of the two clouds at chosen times.

FIG. 12 illustrates the timing diagrams for the application of the various signals for the implementation of a gyroscope sensor, according to the first spatial recombination variant.

FIG. 13 illustrates the movements of the two clouds at chosen times associated with the signals of FIG. 12.

FIG. 14 illustrates the timing diagrams for the application of the various signals for the implementation of a gyroscope sensor according to the second spatial recombination variant.

FIG. 15 illustrates the movements of the two clouds at chosen times associated with the signals of FIG. 14.

### DETAILED DESCRIPTION

The Ramsey time T_{R} is broken down into two times, a time TR^{off} during which no microwave signal is applied to the waveguides, and a time TR^{on} during which microwave signals are applied to the guides:

$${T}_{R} = {T}_{R}^{On} + {T}_{R}^{Off}$$

The noise N accumulated on the phase of the interferometer is given by:

$$N = {σ}_{D C} {T}_{R} + {σ}_{M W} {T}_{R}^{O n} \qquad ( 17 )$$

where σ_{MW} is the phase noise of the interferometer integrating the noise produced by the microwave signals (only during T^{on}) and σ_{DC} is the noise due to the DC magnetic field alone (present throughout the sequence).

The unit of σ_{MW} and σ_{DC} is Hz.

Proceeding from formula 14, assuming that there is an error or noise SB on the DC magnetic field and errors or noise δΩₐ and δω_{b} on Ωₐ and ω_{b}, it is possible to rewrite the difference of the two movements ΔE in the form:

$$Δ E = \frac{ℏ}{4} [ \frac{{Ω}_{a}^{2}}{{Δ}_{a}} + \frac{{Ω}_{b}^{2}}{{Δ}_{b}} + \frac{2 {Ω}_{a}}{{Δ}_{a}} δ {Ω}_{a} + \frac{2 {Ω}_{b}}{{Δ}_{b}} δ {Ω}_{b} + αδ B ( \frac{{Ω}_{a}^{2}}{{Δ}_{a}^{2}} + \frac{{Ω}_{b}^{2}}{{Δ}_{b}^{2}} ) ]$$

The effect of noises or errors on ωₐ and ω_{b} has been disregarded because their effects are negligible in experiments.

The term σ_{MW}, with:

$${σ}_{M W} = \frac{2 {Ω}_{a}}{{Δ}_{a}} δ {Ω}_{a} + \frac{2 {Ω}_{b}}{{Δ}_{b}} δ {Ω}_{b} + αδ B ( \frac{{Ω}_{a}^{2}}{{Δ}_{a}^{2}} + \frac{{Ω}_{b}^{2}}{{Δ}_{b}^{2}} ) \qquad ( 18 )$$

then constitutes noise on the phase of the interferometer, to which it is necessary to add the noise on the other terms contained in the phase of the interferometer, that is to say in the energy difference E_{b}−Eₐ. To simplify, collisional shift, detection noise, the Dicke effect, etc. are disregarded and only the term corresponding to the energy difference in the presence of the DC magnetic field is kept. The noise on this term (microwave fields turned off) involves only the noise on the DC magnetic field δB and is of the form (see for example the publication “Magnetically trapped atoms for compact atomic clocks” P. Rosenbusch, Appl. Phys. B (2009), 95, p 227-235):

$${σ}_{D C} = 2 b ( B - {B}_{m} ) δ B \qquad ( 19 )$$

To put orders of magnitude on the various noises, the example of rubidium 87 gives:

$$b = 431 Hz / {G}^{2} ,$$

the DC magnetic field is close to Bₘ=3,23 G.

$${Δ}_{a} = - {Δ}_{b} = 200 kHz$$

$${Ω}_{a} = 50 kHz and {Ω}_{b} = 50 kHz$$

$$δ B = 1 mG$$

$$B - {B}_{m} = 100 mG$$

$$δ {Ω}_{a} / {Ω}_{a} = δ {Ω}_{b} / {Ω}_{b} = 1 {0}^{- 3}$$

$$This gives :$$

$$\frac{2 {Ω}_{a}}{\vert {Δ}_{a} \vert} {δΩ}_{a} + \frac{2 {Ω}_{b}}{\vert {Δ}_{b} \vert} δ {Ω}_{b} + αδ B ( \frac{{Ω}_{a}^{2}}{{Δ}_{a}^{2}} + \frac{{Ω}_{b}^{2}}{{Δ}_{b}^{2}} ) \approx 100 Hz$$

$$and$$

$$2 b ( B - {B}_{m} ) δ B \approx 100 mHz$$

It may be seen that the presence of the two microwave fields greatly increases the noise level. This is the overriding factor that it is necessary to reduce.

The idea of the invention is to reduce the noise level by replacing the microwave fields (after the two states have been separated) with DC currents in order to create two magnetic traps each containing a state.

Thus, throughout the phase in which the two states |a> and |b> are kept separate, the two microwave fields used for dressing are cut. During this phase of the interferometer, the phase is no longer sensitive to the noise on the DC magnetic field δB or on the amplitude of the microwave fields δωₐ and δω_{b} via the noise term σ_{MW}, but the term σ_{DC} itself remains sensitive to SB.

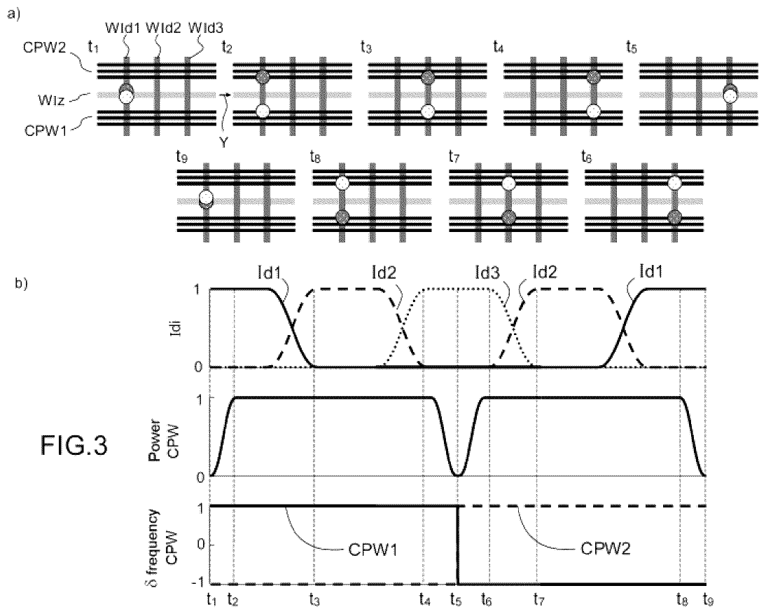

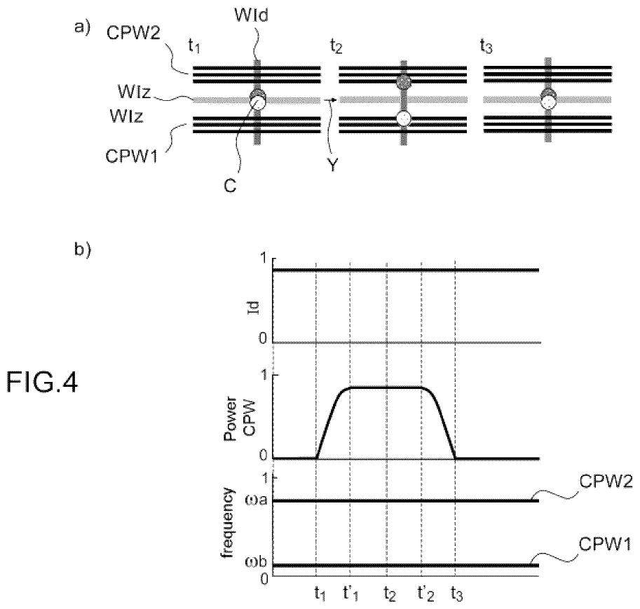

Microwave signals, typically microwave currents I_{MW}, are first applied to separate the two clouds (initialize the spatial separation), as illustrated in FIGS. 3 and 4 from t₁ and to t₂. This step of gradually turning on the waveguides is similar to what has been described in the prior art.

Next, according to the invention, the currents I_{MW} are cut and DC currents I_{DC-MW} are applied instead to the microwave guides CPW1 and CPW2. Before and during the change in the type of current applied to the waveguide, DC currents are applied to the conductive wires.

It is important to use microwave currents for the initial separation of the two states |a> and |b> of the interferometer because microwave currents make it possible to create selective traps of the internal state, unlike DC currents. It is important to create selective traps of the internal state at the start of the separation, otherwise the two states would remain mixed after the separation.

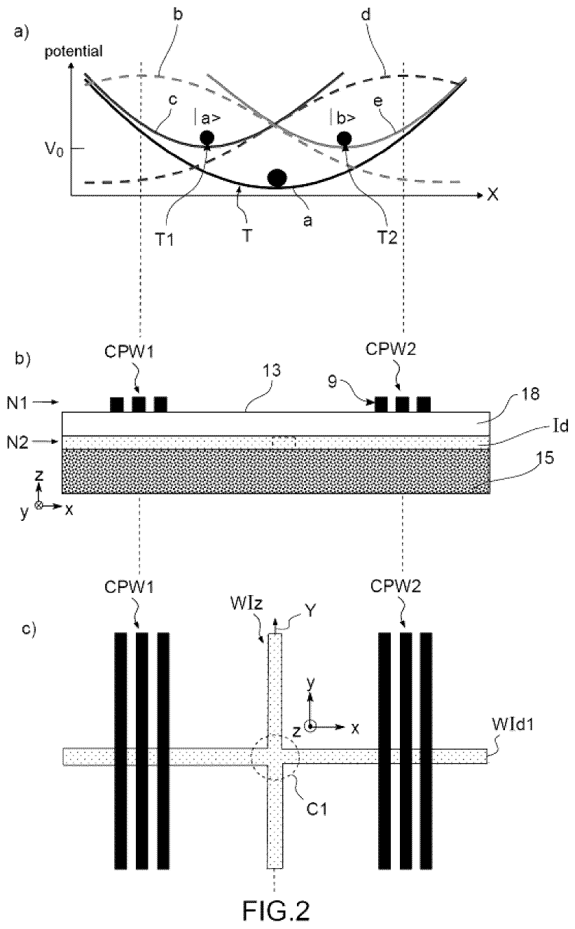

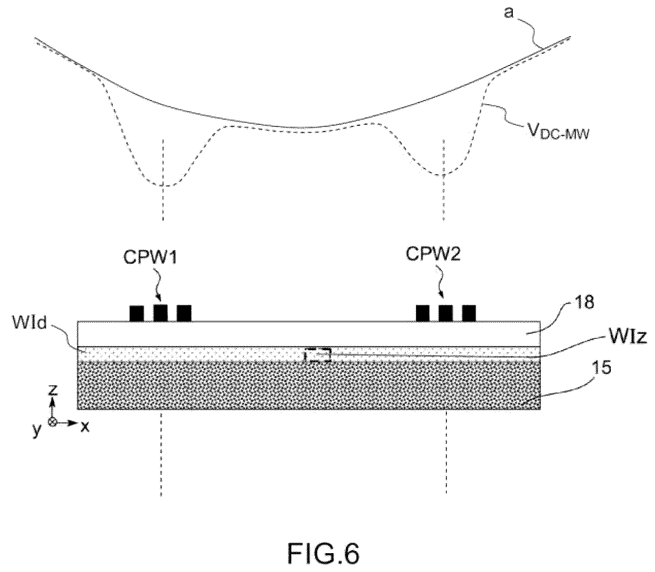

The DC magnetic potential V_{DC-MW} created by applying these DC currents I_{DC-MW} to the waveguides is illustrated in FIG. 6. This magnetic potential V_{DC-MW} replaces the DC magnetic potential created by the microwave fields resulting from the application of the microwave currents I_{MW}, illustrated by curves c) and e) in FIG. 2a). The magnetic potential V_{DC-MW} makes it possible to continue to trap cold atoms and to maintain the spatial separation of the two clouds as far as necessary during the rest of the Ramsey sequence. Curve a) taken from FIG. 2 a) illustrates the DC magnetic potential created by applying DC currents in the two conductive wires (start of the sequence, before the clouds are separated and therefore before the microwave currents are turned on).

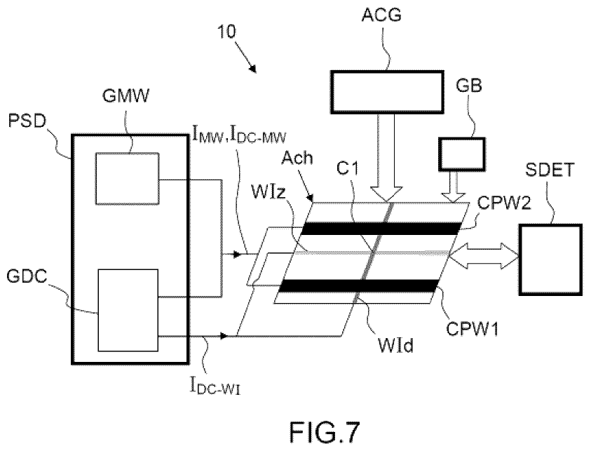

FIG. 7 illustrates an ultracold-atom sensor 10 according to the invention. The sensor 10 comprises an atom chip ACh placed in a vacuum chamber, having an XY-plane referred to as a measurement plane normal to a Z-axis. The chip ACh has a first waveguide CPW1 and a second waveguide CPWX2 that are suitable for propagating microwave waves and DC currents, and at least a first conductive wire WIz and a second conductive wire WId the respective projections of which are secant at a point defining a first crossing point C1. The two waveguides are arranged symmetrically to an axis Y; typically, but without limitation, they are parallel to one another. The sensor also comprises an atom generation device ACG configured to generate a cloud CL of ultracold atoms near said XY-plane of said atom chip and a generator GB for generating a uniform magnetic field Bc.

The sensor 10 according to the invention also comprises a power supply device PSD comprising at least one microwave generator GMW and at least one DC current generator GDC. There may be one microwave generator per guide or one generator for both guides. Similarly, there may be a single common generator GDC for all of the wires and waveguides, or multiple generators.

The power supply device PSD is configured to apply microwave signals, typically currents I_{MW}, and DC electric currents I_{DC-MW}, referred to as CMW currents, to the waveguides CPW1 and CPW2, and to apply DC currents I_{DC-WI}, referred to as CWI currents, to the conductive wires.

The waveguides, the conductive wires and the power supply device are configured, when the sensor is implemented, i) to spatially separate a first cloud of ultracold atoms CL1 in a first internal state |a> from a second cloud of ultracold atoms CL2 in a second internal state |b>, forming a first ultracold-atom trap T1 and a second trap T2, respectively, by modifying the energy of the atoms, and ii) to move the traps (T1, T2) along a linear or closed path contained in a plane perpendicular to Z.

According to the invention, the power supply device PSD is configured to apply, to the first and second waveguides and to spatially separate the two traps, the microwave signals I_{MW} in order to initiate the spatial separation, and then the CMW electric currents I_{DC-MW} instead of the microwave (current) signals I_{MW} in order to maintain the spatial separation.

Finally, the sensor 10 according to the invention comprises a detection system SDET suitable for measuring at least one population of said ultracold atoms in a said internal state.

The cold-atom sensor has a structure identical to that described in the prior art, with the difference that the waveguides are able to propagate DC currents and that the power supply device makes it possible to apply DC currents to the waveguides as claimed.

By applying DC currents to the guides instead of applying microwave signals during a large part of the Ramsey sequence, the noise component due to these signals σ_{MW}T_{R}^{on} (formula 17) is considerably reduced due to the decrease in T_{R}^{on}. This thus reduces the amount of noise accumulated on the phase of the interferometer. It has been shown above that this noise component is the one that limits the measurement, and any gain on this noise component translates directly into a gain in measurement sensitivity.

A first type of sensor according to the invention is an accelerometer, and the path followed by the two traps is linear as illustrated in FIG. 4 a). Two wires IWz and Iwd secant at C1 are needed to define the start/end point of the path, and the movement here is coincident with the spatial separation.

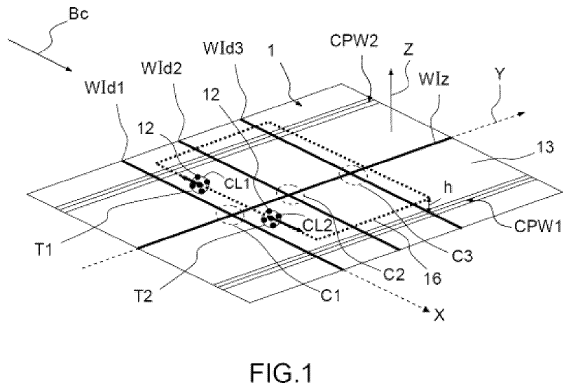

A second type of sensor is a gyroscope. The atom chip then comprises a plurality of second conductive wires WIdi (WId1, WId2, WId3) defining a plurality of crossing points Ci (C1, C2, C3) as illustrated in FIG. 1, and the path followed by the two traps is closed and traveled in the opposite direction by the two traps, as described in FIG. 3a).

The gyroscope according to the invention is compatible with any atom chip geometry comprising two microwave guides and conductive wires, as described in abovementioned documents U.S. Ser. No. 15/778,605, U.S. Ser. No. 17/924,340, U.S. Ser. No. 17/832,615 and U.S. Ser. No. 17/832,616.

When implementing the sensor according to the invention, the two clouds are separated with the microwave signals and, once the clouds have been separated, the separation is maintained with the CMW DC currents applied to the waveguides. The microwave fields may be cut and replaced with two DC currents in three different ways.

In a first variant, the power supply device PSD is configured such that the turning off of the microwave signals takes place at the same time as the turning on of the DC electric currents. This mode allows fast turning off of the microwave currents, and therefore makes it possible to reduce T_{R}^{on}(see equation (17)) and therefore to reduce the accumulation of noise due to the term σ_{MW}.

According to a first embodiment, the time tₜᵣₐₙₛ during which the turning off and turning on take place simultaneously is fast, this meaning that the rising or falling edge is fast compared to the frequencies of the magnetic trap. Typically, tₜᵣₐₙₛ must be less than or equal to 100 μs.

According to a second embodiment, the simultaneous turning off and turning on take place with two slow ramps (a slow falling RF ramp and at the same time a rising DC ramp), this meaning that the ramps must be slow compared to the frequencies of the magnetic trap. Typically, tₜᵣₐₙₛ must be at least 10 ms.

Between these two values of tₜᵣₐₙₛ, according to a third embodiment, the ramps have complex shapes so as to make adiabatic shortcuts.

In a second variant, the power supply device PSD is configured such that the turning off of the microwave signals takes place before the turning on of the CMW electric currents. This mode allows even faster turning off of microwave currents than the first mode, but complicates the transfer between traps using microwave currents I_{MW} and traps using DC currents I_{DC-MW}. The time during which nothing is applied is called tᵢₙₜ. This time should be less than the reciprocal of the frequency of the trap ωₚ. The frequency of the trap illustrates its “stiffness”. The shape of the magnetic potential forming the trap is approximated in the vicinity of the minimum by a parabola. Let r be the distance to the potential minimum V₀, and it is possible to write the potential as:

$$V = {V}_{0} + \frac{1}{2} m {ω}_{p}^{2} {r}^{2}$$

It is therefore necessary that:

$${t}_{int} \leq \frac{1}{{ω}_{p}}$$

In a third variant, the power supply device PSD is configured such that the turning off of the microwave signals takes place after the turning on of the CMW electric currents. This mode simplifies transfer between traps using microwave currents I_{MW} and traps using DC currents I_{DC-MW}.

According to one embodiment, each waveguide comprises three wires, two external ground wires and an internal signal wire, and the DC current CMW is injected into the signal wire (coplanar guides). However, the sensor 10 according to the invention may integrate any type of microwave guide compatible with the application of DC currents, such as microstrips.

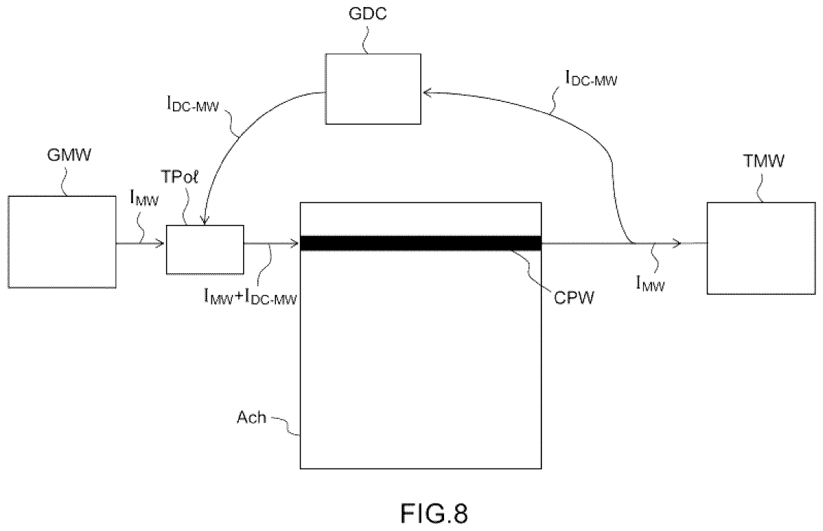

According to one embodiment, the superposition of a microwave current and a DC current in the signal wire of the waveguide is carried out with a bias tee. The power supply device PSD thus furthermore comprises at least one bias tee TPol connected to the microwave generator and to the DC current generator, and configured, at the input of each guide, to apply the microwave signal (microwave current I_{MW}) and the CMW current (DC current I_{DC-MW}) to the waveguides, as illustrated in the block diagram of FIG. 8. A bias tee is a component comprising two inputs, one for a DC current, the other for an oscillating current, and an output for superposing the DC current and the oscillating current. The output may also be used as an input for superposing the DC current and the oscillating current, and the two inputs are then two outputs, one giving the DC current and the other giving the oscillating current. In order to avoid unwanted reflections of the microwave signal that has passed through the microwave guides, a microwave termination TMW is integrated at the atom chip output, as also illustrated in FIG. 8.

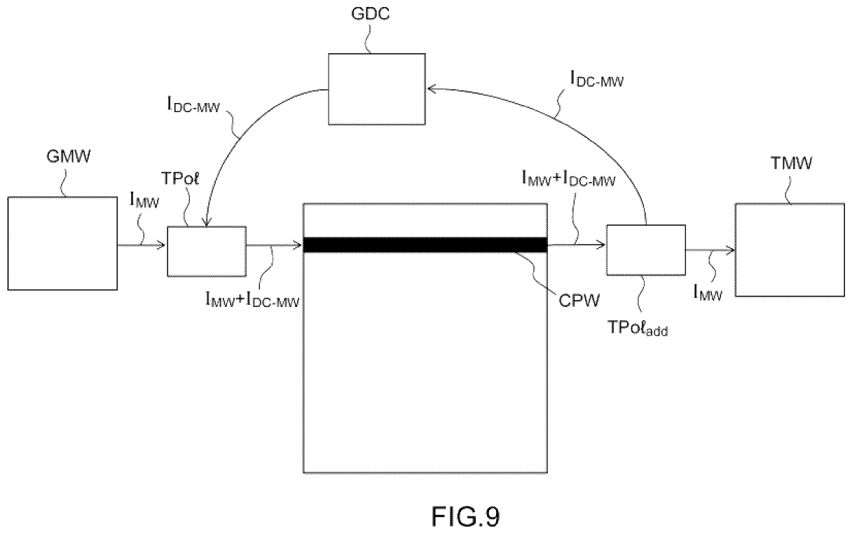

Preferably, in order to ensure good separation between the DC currents and the microwave signals at the output of the microwave guide, an additional bias tee T-Pol_{add} is integrated at the output of the waveguide and before the termination TMW, as illustrated in the block diagram of FIG. 9.

According to another aspect, the invention relates to a method for measuring an inertial parameter using an ultracold-atom sensor according to the invention as described above. The method comprises a first step A of generating a cloud CL of ultracold atoms near the XY-plane of the atom chip, including phases of dispensing the atoms, of cooling the atoms, of initializing the atoms to at least a first internal state, and of trapping a cloud of ultracold atoms in a local potential minimum, at a controlled height from the measurement XY-plane, the trapping being carried out by passing DC currents through the first and second conductive wires. This step is similar to step A0 described in the prior art.

In a step B, the first internal state |a> and the second internal state |a> of the ultracold atoms are initialized by coherently superposing the ultracold atoms between the first and second internal states by way of a π/2 pulse. This step is similar to step B0 described in the prior art.

In a step C, the first cloud of ultracold atoms in the first internal state is spatially separated from the second cloud of ultracold atoms in the second internal state, forming a first ultracold-atom trap T1 and a second ultracold-atom trap T2, respectively. This separation is carried out by modifying the energies of the ultracold atoms. The traps (T1, T2) are then moved along a linear path (accelerometer) or a closed path (gyroscope) contained in a plane perpendicular to Z and initialized at the first crossing point.

Step C of separating and moving the ultracold atoms is carried out by applying, in a predetermined sequence:
a uniform magnetic field Bc to the ultracold atoms,
DC currents, referred to as CWI currents, to the conductive wires,
microwave signals, typically microwave currents I_{MW}, and DC electric currents,
referred to as CMW currents, to the waveguides.

In the method according to the invention, the separation step comprises an initialization sub-step Cinit comprising applying microwave signals to said waveguides, and a maintenance sub-step Cmaint comprising applying CMW electric currents instead of said microwave signals. The originality of the method according to the invention lies in the separation and movement step C, and particularly in the step Cmaint.

In a step D, the first and second internal states are recombined (the two clouds are then spatially merged again once the path has been traveled) by applying a second π/2 pulse to the ultracold atoms, thereby finishing the Ramsey sequence initialized with the first π/2 pulse. This step is similar to step D0 described in the prior art.

Finally, in a step E, at least one population of ultracold atoms in at least one said internal state is measured, from which a value of an inertial parameter (acceleration, speed and/or angle of rotation with respect to a given axis) is deduced. This step is similar to step E0 described in the prior art.

In the method according to the invention, the usual sequence used to separate and recombine the two states |a> and |b> is modified.

The usual sequence consists in:
Gradually turning on the two microwave fields each in a waveguide (CPW1 and CPW2) of the chip, thereby making it possible to separate the two states |a> and |b>;
Maintaining the two microwave fields in the guides CPW1 and CPW2 so as to maintain the two separate states |a> and |b> (this separation with the microwave fields is shown in FIG. 2a));
Gradually turning off the two microwave fields so as to spatially recombine the two states |a> and |b>. This spatial recombination is different from the recombination in step D. The spatial recombination takes place once just before step D for the accelerometer (time t₃ in FIG. 4a)), and takes place twice when traveling the closed path for the gyrometer (time t₅ and t₉ in FIG. 3a)).

The sequence according to the invention is described below for the example of a three-wire coplanar waveguide.
Gradually turning on the two microwave fields each in a waveguide of the chip, thereby making it possible to separate the two states |a> and |b>;
Once the states have been separated, cutting, preferably quickly, the two microwave fields and turning on, preferably at the same time and quickly, a DC current in the two signal lines of the two microwave guides. This makes it possible to create two separate DC magnetic traps, each containing one of the two internal states |a> and |b> (these two traps are shown in FIG. 6);
Spatially recombining the two states, in the movement step, according to two variants:

According to a first variant, by gradually turning off the two DC currents passing through the two signal lines of the two microwave guides;

According to a second variant, by turning off, preferably quickly, the two DC currents passing through the two signal lines of the two microwave guides and, preferably at the same time, by quickly turning the two microwave fields back on, and then by gradually turning off the two microwave fields in order to recombine the two states |a> and |b>.

Preferably, the separation step of the method according to the invention comprises a transient sub-step Ctrans between the initialization sub-step Cinit and the maintenance sub-step Cmaint, comprising turning off the microwave signals and turning on the CMW currents.

The microwave fields may be cut and replaced with two DC currents according to the three variants described above:

First variant: during the transient step, the turning off of the microwave signals and the turning on of the CMW currents take place at the same time. Preferably, the transient step has a duration of less than 100 μs.

Second variant: during the transient step, the turning off of the microwave signals takes place before the turning on of the CMW currents.

Third variant: during the transient step, the MW signals are turned off after the CMW currents are turned on.

The method according to the invention will now be illustrated using examples of timing diagrams.

The following notations are used:
P1_{MW} and P2_{MW} denote the power of the microwave signal respectively applied to the guide CPW1 and CPW2,
ωₐ denotes the angular frequency sent to the waveguide CPW2 and ω_{b} denotes the angular frequency sent to the waveguide CPW1,
Iz denotes the strength of the DC current applied to the first conductive wire WIz,
Id, Id₁, Id₂, Id₃ denote the strengths of the DC currents, referred to as CWI currents, applied to the one or more second conductive wires,
I1_{DC-MW} and I2_{DC-MW} denote the strengths of the DC currents, referred to as CMW currents, applied to the waveguides CPW1 and CPW2, respectively.

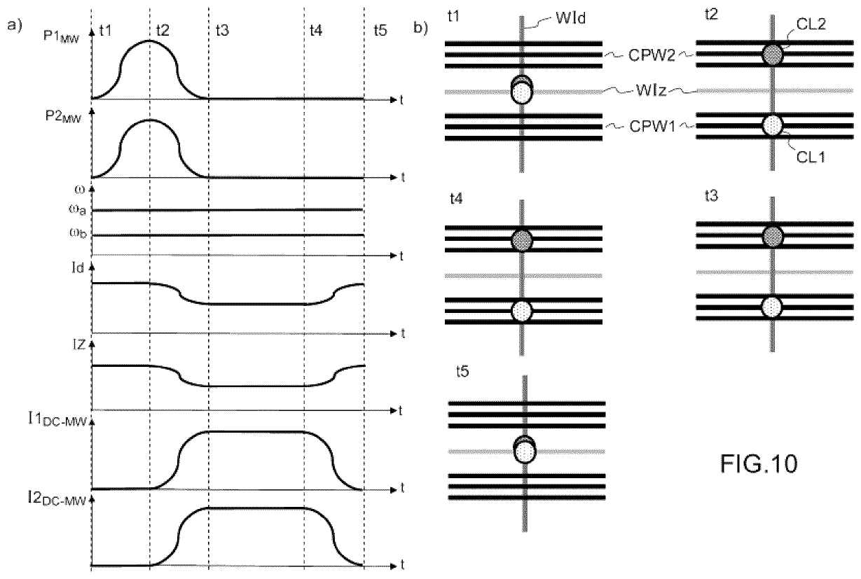

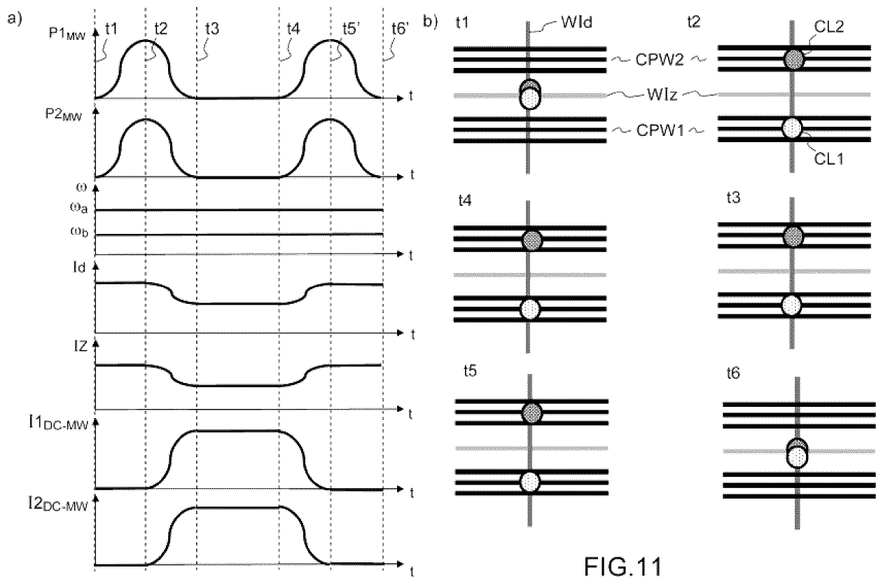

FIGS. 10a) and 11a) illustrate the timing diagrams for the application of the various signals when implementing an accelerometer sensor according to the first and second spatial recombination variant, respectively, during the separation/movement step C. FIGS. 10b) and 11b) illustrate the movement of the two clouds at chosen times. These figures also illustrate the first variant of the turn-off/turn-on sequencing, that is to say switching off the MW powers at the same time as switching on the CMW currents.

Throughout the sequence, an angular frequency ωₐ is applied to CPW2 and an angular frequency ω_{b} is applied to CPW1 (idem FIG. 4a)).

In FIG. 10, between t1 and t2, the microwave powers are applied to the guides. At t2, the two clouds CL1 and CL2 are separate. Next, between t₂ and t₃, the MW signal is gradually turned off and the DC currents I1_{DC-MW} and I2_{DC-MW} are turned on at the same time. Between t3 and t4, these currents are maintained for the measurement. Next, between t4 and t5, the currents I1_{DC-MW} and I2_{DC-MW} are gradually reduced, thereby spatially recombining the two clouds (first spatial recombination variant). At t5, the two clouds are spatially recombined.

According to a first embodiment, the currents Id and I_{z} remain constant. According to a second embodiment illustrated in FIG. 10a), the current I_{z} decreases slightly when the currents I1_{DC-MW} and I2_{DC-MW} are applied, in order to increase the potential barrier between the two states (FIG. 6). When these currents are no longer applied, Iz increases slightly again. According to this second embodiment, Id preferably varies like Iz.

In FIG. 11, the start of the sequence is identical until the time t₄. Between t₄ and t5′, at the same time as the DC currents are turned off, the microwave signals are turned back on, and the clouds are still separate. Between t5′ and t6′, spatial recombination is carried out by gradually turning off the MW signals (second spatial recombination variant). At t6′, the two clouds are spatially recombined.

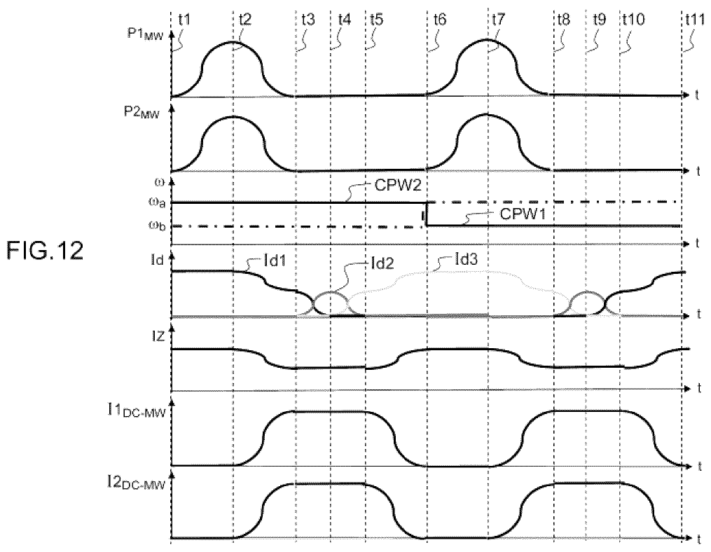

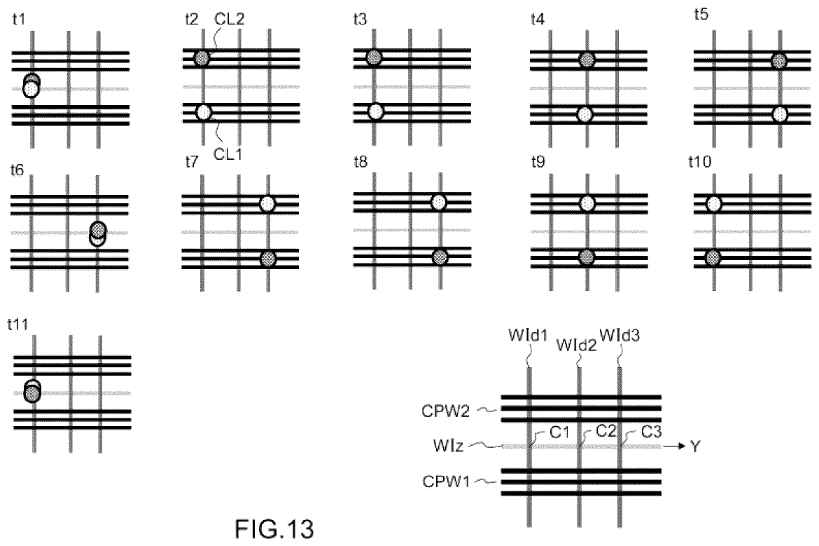

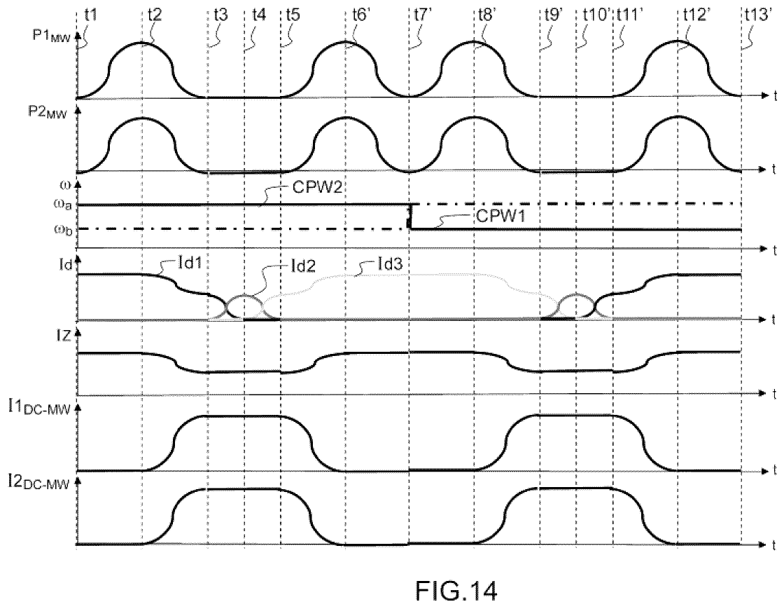

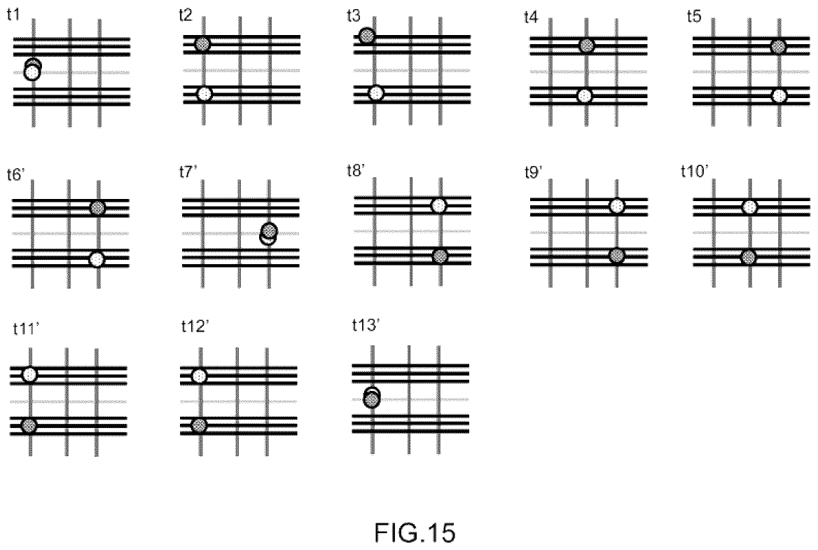

FIGS. 12 and 14 illustrate the timing diagrams for the application of the various signals respectively for implementing a gyroscope sensor, according to the first and second spatial recombination variant, respectively, during the separation/movement step C. FIGS. 13 and 15 illustrate the movements of the two clouds at chosen times. These figures also illustrate the first variant of the turn-off/turn-on sequencing, that is to say switching off the MW powers at the same time as switching on the CMW currents.

In FIGS. 12 and 13, the two clouds are separated by applying MW power to the two guides (between t1 and t2). For this purpose, DC currents Id1 and Idz are applied to WIz and WId1, respectively. Next, between t2 and t3, the MW signals are replaced with the DC currents I1_{DC-MW} and I2_{DC-MW}. Between t3 and t4, the two clouds are moved along Y from the first crossing point C1 to the second crossing point C2 by turning off the current Id1 and turning on the current Id2 in WId2. Between t4 and t5, the two clouds are moved along Y from the second crossing point C2 to the third crossing point C3 by turning off the current Id2 and turning on the current Id3 in WId3. Next, between t5 and t6, the first spatial recombination of the two clouds is carried out at C3 (completing half the travel of the closed path) by turning off the DC currents I1_{DC-MW} and I2_{DC-MW} (first spatial recombination variant). At t6, the frequencies applied to the waveguides are inverted and the second half-trip is started, again separating the two clouds by applying MW fields to the guides between t6 and t7.

Here as well, according to one embodiment illustrated in FIG. 12, the current Iz is slightly decreased during the application of the currents I1_{DC-MW} and I2_{DC-MW} and increased again when they are turned off, and the currents Id1 and Id3 follow the variations of Iz. According to another embodiment, the currents Iz and Id1, Id2 and Id3 do not have two plateaus (see for example variation of Idi in FIG. 3).

In FIGS. 14 and 15, the sequence is identical up to t5. Between t5 and t6′, the DC currents are turned off at the same time as the microwave signals are turned back on, and the clouds are still separate. Between t6′ and t7′, spatial recombination is carried out by gradually turning off the MW signals (second spatial recombination variant). The same will apply between t11′ and t12′, where the DC currents are turned off and the microwave signals are turned on at the same time, and then between t12′ and t13′, spatial recombination is carried out by gradually turning off the MW signals.

1. An ultracold-atom sensor comprising:
an atom chip (ACh) placed in a vacuum chamber, comprising an XY-plane,
referred to as a measurement plane, normal to a Z-axis, and comprising:
a first and a second waveguide (CPWX1, CPWX2) that are suitable for propagating microwave waves and DC currents,
at least a first conductive wire (WIz) and a second conductive wire (WId, WId1) the respective projections of which are secant at a point defining a first crossing point (C1),
an atom generation device (ACG) configured to generate a cloud of ultracold atoms near said XY-plane of said atom chip,
a generator (GB) for generating a uniform magnetic field (Bc),
a power supply device (PSD) comprising at least one microwave generator (GMW) and at least one DC current generator (GDC), the power supply device being configured to:
apply microwave signals (I_{MW}) and DC electric currents (I_{DC-MW}),
referred to as CMW currents, to said first and second waveguides,
apply DC currents, referred to as CWI currents, to said conductive wires,
said waveguides, said conductive wires and said power supply device being configured, when the sensor is implemented, to spatially separate a first cloud (CL1) of ultracold atoms in a first internal state from a second cloud (CL2) of ultracold atoms in a second internal state, forming first and second ultracold-atom traps (T1) and (T2), respectively, by modifying an energy of said ultracold atoms, and to move said traps (T1, T2) along a linear or closed path contained in a plane perpendicular to Z,
said power supply device being configured to apply, to said first and second waveguides and to spatially separate the two traps, said microwave signals in order to initiate said spatial separation, and then said CMW electric currents instead of said microwave signals in order to maintain said spatial separation,
the sensor furthermore comprising a detection system (SDET) suitable for measuring at least one population of said ultracold atoms in a said internal state.

2. The sensor according to claim 1, being an accelerometer, said path followed by the two traps being linear.

3. The sensor according to claim 1, being a gyroscope comprising a plurality of second conductive wires (WIdi) defining a plurality of crossing points (Ci), said path followed by the two traps being closed and traveled in the opposite direction by the first and the second trap.

4. The sensor according to claim 1, wherein each waveguide comprises three wires, two external ground wires and an internal signal wire, the CMW current being injected into the signal wire.

5. The sensor according to claim 1, wherein the power supply device furthermore comprises at least one bias tee connected to said at least one microwave generator and to said at least one DC current generator, and configured to apply said microwave signals and said CMW currents to said waveguides.

6. A method for measuring an inertial parameter using an ultracold-atom sensor comprising an atom chip (ACh) placed in a vacuum chamber, comprising an XY-plane normal to a Z-axis referred to as a measurement plane, said atom chip comprising:
a first and a second waveguide (CPWX1, CPWX2) that are suitable for propagating microwave waves and DC currents,
at least a first conductive wire (W1) and a second conductive wire (W2) the respective projections of which are secant at a point defining a first crossing point (O),
the method comprising the following steps:
A Generating a cloud of ultracold atoms near said XY-plane of said atom chip, including phases of dispensing said atoms, of cooling said atoms, of initializing said atoms to at least a first internal state, and of trapping a cloud of said ultracold atoms in a local potential minimum, at a controlled height from said XY-plane, said trapping being carried out by passing DC currents through the first and second conductive wires,
B Initializing the first internal state and a second internal state of said ultracold atoms by coherently superposing said ultracold atoms between said first and second internal states by way of a π/2 pulse,
C Spatially separating a first cloud of ultracold atoms in the first internal state from a second cloud of ultracold atoms in the second internal state by forming a first and second ultracold-atom trap (T1) and (T2), respectively, by modifying energies of said ultracold atoms, and moving said traps (T1, T2) along a linear or closed path contained in a plane perpendicular to Z and initialized at the first crossing point,
said step of separating and moving the ultracold atoms being carried out by applying, in a predetermined sequence, a uniform magnetic field (Bc) to said ultracold atoms, DC currents, referred to as CWI currents, to said conductive wires, and microwave signals (I_{MW}) and DC electric currents, referred to as CMW currents, to said waveguides,
the separation step comprising an initialization sub-step comprising applying said microwave signals to said waveguides, and a maintenance sub-step comprising applying said CMW electric currents instead of said microwave signals,
D Recombining said first and second internal states by applying a second π/2 pulse to said ultracold atoms,
E Measuring at least one population of said ultracold atoms in at least one said internal state.

7. The method according to claim 6, wherein the separation step comprises a transient sub-step between the initialization sub-step and the maintenance sub-step, comprising turning off the microwave signals and turning on the CMW currents.

8. The method according to claim 7, wherein, during the transient step, the turning off of the microwave signals and the turning on of the CMW currents take place at the same time.

9. The method according to claim 8, wherein the transient step has a duration of less than 100 μs.

10. The method according to claim 6, wherein, during the transient step, said turning off of the microwave signals takes place before or after said turning on of the CMW currents.

11. The method according to claim 6, wherein, during the movement step, the two clouds are spatially recombined by gradually turning off the CMW currents.

12. The method according to claim 6, wherein, during the movement step, the two clouds are spatially recombined by turning off the CMW currents and by simultaneously turning the microwave signals back on, and then by gradually turning off the microwave signals.
